(19) United States
(12) Patent Application Publication
(10) Pub. No.: US 2014/0375425 A1
(43) Pub. Date: Dec. 25, 2014

(54) METHODS FOR DYNAMICALLY SENDING ALERTS TO USERS AND DEVICES THEREOF

(71) Applicant: Infosys Limited, Bangalore (IN)

(72) Inventors: Puneet Gupta, Bangalore (IN); Venkat Kumar Sivaramamurthy, Bangalore (IN)

(73) Assignee: Infosys Limited, Bangalore (IN)

(21) Appl. No.: 14/220,492

(22) Filed: Mar. 20, 2014

(30) Foreign Application Priority Data
Jun. 24, 2013 (IN) 2730/CHE/2013

(51) Int. Cl. G08B 27/00

(52) U.S. Cl. CPC G08B 27/00
USPC 340/7.58

(57) ABSTRACT

A method, non-transitory computer readable medium and device for sending an alert to at least one customer through a communication network. This technique involves uploading the alert content in different formats into an operator's system to send the same to customers. Then, the spare capacity of delivery channels is identified which are available to send the alert to the customer. Thereafter, the at least one delivery channel among the all identified channels and best suitable alert format for that delivery channel is selected based on the spare capacity of the channel and predefined profile of the customer. Finally, the alert is sent to the customer in the selected format through the selected delivery channel.

This application claims the benefit of Indian Patent Application Filing No. 2730/CHE/2013, filed Jun. 24, 2013, which is hereby incorporated by reference in its entirety.

### FIELD

This technology generally relates to render alerts to customer and, in particular, to methods for sending an alert to at least one customer through communication network by dynamically selecting an alert format and channel of delivery and devices thereof.

### BACKGROUND

With the great progress on every front of telecommunications, many new types of uses of these technologies emerge. One thrust of evolution involves delivering alert or notification to the customers. Merchants may be interested to send the notifications or advertisements or alerts to the customers, particularly, merchants need a mechanism to create long lasting impact on end users with best possible marketing alert notifications. On the other hand, operators may be interested in monetizing unutilized spare capacity of network channels. Thus, operators can generate new revenue stream by enabling merchants to utilize the spare capacity of network channels and charging for it.

Presently, alerts are delivered in a specific format on a specific channel, where the format and channel are predefined. Thus, if the network resources of the predefined channel are not available at a certain point of time then the operator has to wait for the resources to be free to deliver the alerts. So, this approach cannot take advantage if there is an opportunity to render better format on a different channel and thereby creating a poor impact on the users.

### SUMMARY

The present technique overcomes the limitations mentioned above by dynamically selecting alert formats and channel of delivery based on the current available bandwidth offered by a cell tower servicing the current user.

A method for sending an alert to at least one customer through communication network includes uploading the alert in one or more formats into a system for sending to the at least one customer. Thereafter, spare capacity of one or more channels available to send the alert to the at least one customer is identified. Further, at least one of the one or more channels and at least one of the one or more alert formats are selected based on the spare capacity of the one or more channels. In various examples of this technology, the selection step further includes determining available bandwidth, quality of service, authorization to access the at least one channel, billing rates, user preference, merchant preference, operator preference, customer profile, location, time or combination thereof. Finally, the alert is sent to the at least one customer in the at least one of the one or more formats through the at least one selected channel of delivery.

A communication management computing device that sends an alert to at least one customer through communication network includes an alert uploading module, a spare capacity identification module, a channel of delivery and alert format selection module and a alert sending module. The alert uploading module is configured to upload the alert in one or more formats into a system for sending to the at least one customer. The spare capacity identification module is configured to identify spare capacity of one or more channels available to send the alert to the at least one customer. The channel of delivery and alert format selection module is configured to select at least one of the one or more channels and at least one of the one or more alert formats based on the spare capacity of the one or more channels. In various examples of this technology, the selection step further includes determining available bandwidth, quality of service, authorization to access the at least one channel, billing rates, user preference, merchant preference, operator preference, customer profile, location, time or combination thereof. Finally, the alert sending module is configured to send the alert to the at least one customer in the at least one of the one or more formats through the at least one selected channel of delivery.

In another example, a non-transitory computer readable storage medium for sending an alert to at least one customer through communication network is disclosed. The non-transitory computer readable storage medium which is not a signal stores computer executable instructions for uploading the alert in one or more formats into a system for sending to the at least one customer, identifying spare capacity of one or more channels available to send the alert to the at least one customer, selecting at least one of the one or more channels and at least one of the one or more alert formats based on the spare capacity and sending the alert to the at least one customer in the at least one of the one or more formats through the at least one selected channel of delivery.

### BRIEF DESCRIPTION OF THE DRAWINGS

Various examples of the invention will, hereinafter, be described in conjunction with the appended drawings. There is no intention to limit the scope of the invention to such blocks or objects, or to any particular technology. Instead these simplified diagrams are presented by way of illustration to aid in the understanding of the logical functionality of one or more aspects of the instant disclosure and is not presented by way of limitation.

FIG. 1 is a computer architecture diagram illustrating a communication management computing device capable of implementing the examples presented herein.

FIG. 2 is a flowchart, illustrating a method for sending an alert to at least one customer through communication network, in accordance with an example of this technology.

FIG. 3 is a block diagram illustrating examples of modules of programmed instructions for sending an alert to at least one customer through communication network, in accordance with examples of this technology.

### DETAILED DESCRIPTION

The foregoing has broadly outlined the features and technical advantages of this technology in order that the detailed description of the disclosure that follows may be better understood. Additional features and advantages of the disclosure will be described hereinafter which form the subject of the claims of the disclosure. It should be appreciated by those skilled in the art that the conception and specific example disclosed may be readily utilized as a basis for modifying or designing other structures for carrying out the same purposes of this technology. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of this technology.

Exemplary examples of this technology provide a system and method for sending an alert to at least one customer through communication network. This involves uploading the alert content in different formats into an operator's system to send the same to customers. Then, the spare capacity of delivery channels is identified which are available to send the alert to the customer. Thereafter, the at least one delivery channel among the all identified channels and best suitable alert format for that delivery channel is selected based on the spare capacity of the channel, available bandwidth, quality of service, authorization to access the at least one channel, billing rates, user preference, merchant preference, operator preference, customer profile, location, time or combination thereof. Finally, the alert is sent to the customer in the selected format through the selected delivery channel.

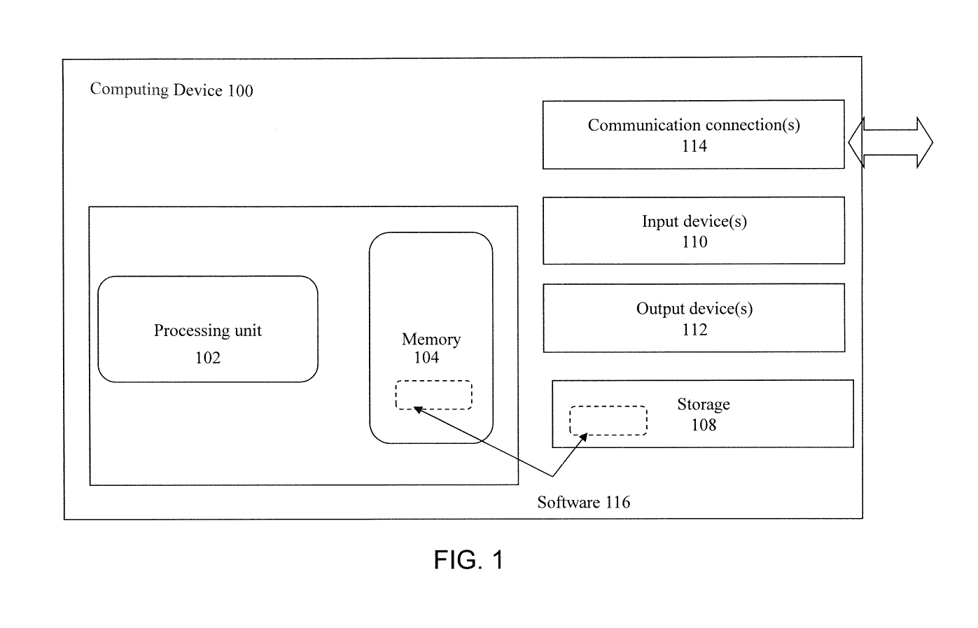

FIG. 1 illustrates a generalized example of a communication management computing device 100 in which all examples, techniques, and technologies of this invention may be implemented. The communication management computing device 100 is not intended to suggest any limitation as to scope of use or functionality of the technology, as the technology may be implemented in diverse general-purpose or special-purpose computing devices. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the communication management computing device 100 includes at least one central processing unit 102 and memory 104, although other types and/or numbers of computing devices with other types and/or numbers of systems, devices, components and/or other may be used. The central processing unit 102 executes computer-executable instructions. In a multi-processing system, multiple processing units execute non-transitory computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software 116 that can implement the technologies described herein. A communication management computing device may have additional features. For example, the communication management computing device 100 includes storage 108, one or more input devices 110, one or more output devices 112, and one or more communication connections 114. An interconnection mechanism (not shown) such as a bus, a controller, or a network, interconnects the components of the communication management computing device 100. Typically, operating system software (not shown) provides an operating environment for other software executing in the communication management computing device 100, and coordinates activities of the components of the communication management computing device 100.

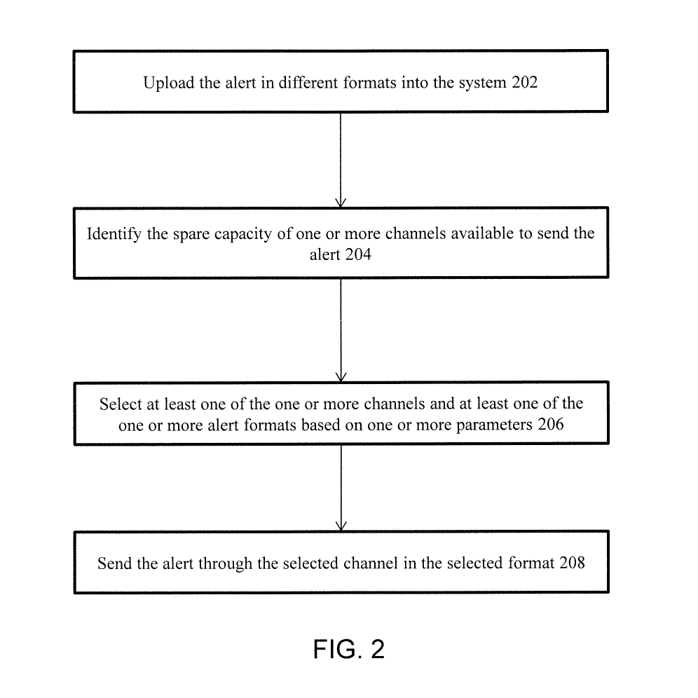

FIG. 2 is a flowchart, illustrating a method for sending an alert to at least one customer through communication network, in accordance with an example of this technology. The alerts are uploaded in different formats into the system managed by an operator, as in step 202. The alerts are uploaded by one or more merchants. In an alternate example, merchant and operator can be same entity. The examples of different alert formats may include, but are not limited to text, audio, video, webpage or combination thereof. The alert is triggered by the operator's system based on various parameters. The example of various parameters may include but are not limited to customer, merchant or system's identified preferences on location, profile, time and so on. For sending the alert to the customer the current serving cell tower of the customer is identified by the operator's system. After that, the available channels of the serving cell tower and their spare capacity to deliver the alert are identified by the operator's system, as in step 204. The examples of various channels may include but are not limited to short messaging services (SMS), unstructured supplementary service data (USSD), voice, data channels or combination thereof. The examples of various data channels may include but not limited to general packet radio service (GPRS), universal mobile telecommunication system (UMTS), high-speed downlink packet access (HSDPA) and so on. The at least one available channel is selected by the operator's system, as in step 206. In a preferred example, the at least one available channel is the best available channel. The at least one available channel is selected based on the available bandwidth, quality of service (QoS), security, authorization to access the channel, billing rates, customer profile, customer preference, merchant preference, operator preference, location, time or combination thereof. The customer profile is defined either by merchant or operator or both. In accordance with an example of this technology, the advertiser or merchant may subside the access even if the customer has not availed a data service. The best alert format that can be delivered through the selected channel is identified, as in step 206. For example, a customer services by a cell tower which is busy on data or circuit switched channel, i.e. handling large amount of data or circuit switched call, can deliver text message on a SMS channel; on the other hand, a customer services by a cell tower which is handling low data traffic can deliver video alert on data channel. The above mentioned examples are provided only for understanding purpose and do not intent to limit the scope of the disclosure. Finally, the alert in the selected format is sent to the customer on the selected channel by the operator's system, as in step 208.

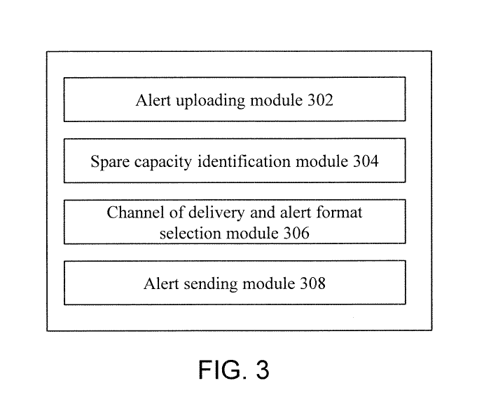

FIG. 3 is a block diagram illustrating examples of modules of programmed instructions stored in memory or other storage in the communication management computing device 100 for sending an alert to at least one customer through communication network, in accordance with an example of this technology, although other types and/or numbers of modules, programmed instructions and/or data which may be stored in other internal and/or external locations may be used. In this example, the memory 104 in the communication management computing device 100 includes an alert uploading module (302), a spare capacity identification module (304), a channel of delivery and alert format selection module (306) and an alert sending module (308). The alert uploading module (302) is configured to upload the alert in one or more formats into a system for sending to the at least one customer. The alerts are uploaded by one or more merchants. In an alternate example, merchant and operator can be same entity. The examples of different alert formats may include, but are not limited to text, audio, video, webpage or combination thereof. The spare capacity identification module (304) is configured to identify spare capacity of one or more channels available to send the alert to the at least one customer. The examples of various channels may include but are not limited to short messaging services (SMS), unstructured supplementary service data (USSD), voice, data channels or combination thereof. The examples of various data channels may include but not limited to general packet radio service (GPRS), universal mobile telecommunication system (UMTS), high-speed downlink packet access (HSDPA) and so on. The channel of delivery and alert format selection module (306) is configured to select at least one of the one or more channels and at least one of the one or more alert formats based on the spare capacity and a predefined profile of the at least one customer. In a preferred example, the at least one available channel is the best available channel. The at least one available channel is selected based on the available bandwidth, quality of service (QoS), security, authorization to access the channel, billing rates, customer profile or combination thereof. The customer profile is defined either by merchant or operator or both. In accordance with an example of this technology, the advertiser or merchant may subside the access even if the customer has not availed a data service. The alert sending module (308) is configured to send the alert to the at least one customer in the at least one of the one or more formats through the at least one selected channel of delivery.

The above mentioned description is presented to enable a person of ordinary skill in the art to make and use the invention and is provided in the context of the requirement for obtaining a patent. Various modifications to the preferred example will be readily apparent to those skilled in the art and the generic principles of this technology may be applied to other examples, and some features of this technology may be used without the corresponding use of other features.

Accordingly, this technology is not intended to be limited to the example shown but is to be accorded the widest scope consistent with the principles and features described herein.

What is claimed is:

1. A method for sending an alert to at least one customer through communication network, the method comprising:
uploading, by a communication management computing device, the alert in one or more formats into a system for sending to the at least one customer;
identifying, by the communication management computing device, spare capacity of one or more channels available to send the alert to the at least one customer;
selecting, by the communication management computing device, at least one of the one or more channels and at least one of the one or more alert formats based on the spare capacity of the one or more channels; and
sending, by the communication management computing device, the alert to the at least one customer in the at least one of the one or more formats through the at least one selected channel of delivery.

2. The method as claimed in claim 1, wherein the one or more formats comprise one or more of text, audio, video, or a webpage.

3. The method as claimed in claim 1, wherein the selecting the at least one of the one or more channels further comprises selecting based on one or more of available bandwidth, quality of service, authorization to access the at least one channel, billing rates, user preference, merchant preference, operator preference, customer profile, location, or time.

4. The method as claimed in claim 3, wherein the selecting is based at least on the customer profile, wherein the customer profile is obtained from and defined by a merchant at a merchant computing device and/or an operator of the communication management computing device.

5. The method as claimed in claim 1, wherein the uploading further comprises uploading, by the communication management computing device, the alert from a merchant computing device.

6. The method as claimed in claim 1, wherein the at least one channel of delivery comprises a message service, short message services (SMS), unstructured supplementary service data (USSD), voice, or a data channel.

7. The method as claimed in claim 1, wherein the at least one available channel comprises best available channel.

8. A communication management computing device comprising:
at least one processor;
at least one memory coupled to the processor configured to execute programmed instructions stored in the memory comprising:
uploading an alert in one or more formats for sending to at least one customer;
identifying spare capacity of one or more channels available to send the alert to the at least one customer;
selecting at least one of the one or more channels and at least one of the one or more alert formats based on the spare capacity of the one or more channels; and
sending the alert to the at least one customer in the at least one of the one or more formats through the at least one selected channel of delivery.

9. The device as claimed in claim 8, wherein the one or more formats comprise one or more of text, audio, video, or a webpage.

10. The device as claimed in claim 8, wherein the processor is further configured to execute programmed instructions stored in the memory for the selecting further comprising selecting the at least one of the one or more channels based on one or more of available bandwidth, quality of service, authorization to access the at least one channel, billing rates, user preference, merchant preference, operator preference, customer profile, location, or time.

11. The device as claimed in claim 10, wherein the processor is further configured to execute programmed instructions stored in the memory for the selecting further comprises selecting based at least on the customer profile, wherein the customer profile is obtained from and defined by a merchant and/or an operator.

12. The device as claimed in claim 8, wherein the processor is further configured to execute programmed instructions stored in the memory for the uploading further comprising uploading the alert from a merchant computing device.

13. The device as claimed in claim 8, wherein the at least one channel of delivery comprises one or more of a message service, unstructured supplementary service data (USSD), voice, or a data channel.

14. The device as claimed in claim 8, wherein the at least one available channel comprises a best available channel.

15. A non-transitory computer readable medium having stored thereon instructions for sending an alert to at least one customer through a communication network comprising machine executable code which when executed by at least one processor, causes the at least one processor to perform steps comprising:
uploading the alert in one or more formats for sending to at least one customer;
identifying spare capacity of one or more channels available to send the alert to the at least one customer;
selecting at least one of the one or more channels and at least one of the one or more alert formats based on the spare capacity of the one or more channels; and
sending the alert to the at least one customer in the at least one of the one or more formats through the at least one selected channel of delivery.

16. The non-transitory computer readable medium as claimed in claim 15, wherein the one or more formats comprise one or more of text, audio, video, or a webpage.

17. The non-transitory computer readable medium as claimed in claim 15, wherein the selecting further comprises selecting the at least one of the one or more channels based on one or more of available bandwidth, quality of service, authorization to access the at least one channel, billing rates, user preference, merchant preference, operator preference, customer profile, location, or time.

18. The device as claimed in claim 17, wherein the selecting is based at least on the customer profile, wherein the customer profile is obtained from and defined by a merchant and/or an operator.

19. The non-transitory computer readable medium as claimed in claim 15, wherein the uploading further comprises uploading the alert from a merchant computing device.

20. The non-transitory computer readable medium as claimed in claim 15, wherein the at least one channel of delivery comprises one or more of a message service, unstructured supplementary service data (USSD), voice, or a data channel.

21. The non-transitory computer readable medium as claimed in claim 15, wherein the at least one available channel comprises a best available channel.
